(19) United States
(12) Patent Application Publication
(10) Pub. No.: US 2004/0054766 A1
(43) Pub. Date: Mar. 18, 2004

(54) Wireless resource control system

(76) Inventor: John B. Vicente, Roseville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/245,352

(22) Filed: Sep. 16, 2002

(51) Int. Cl. G06F 15/173

(52) U.S. Cl. 709/223

(57) ABSTRACT

In one embodiment, a multi-tiered wireless resource control system monitors conditions at each of multiple tiers and controls resources at each of multiple tiers based on data collected during monitoring. The multiple tiers of the wireless resource control system include at least a local tier associated with a specific wireless device and a global tier associated with the wireless network.

### FIELD OF THE INVENTION

The present invention relates to network provisioning and management; more particularly, the present invention relates to controlling resources in a wireless environment.

### BACKGROUND

In our information age, achieving the highest network service quality is as important as developing best class of networking products. In the wired networking environment, various network management approaches, network protocols, and standards have been proposed, aiming at improving the network management efficiency and maximizing the utilization of the network. In particular, in the area of quality of service (QoS), mechanisms have been proposed to provide the necessary level of service to applications and to maintain an expected quality level. Some of these mechanisms, for example, classify applications into different levels of service based on certain criteria or policies (e.g., priority) and treat each level of service according to the classification. Based on QoS policies, different kinds of flows can be QoS enabled and network resources can then be allocated according to the specified QoS and the associated policies.

However, in the wireless environment, little progress has been made in the QoS area. The wireless environment is usually associated with multiple fluctuating effects. For example, when a user of a personal digital assistant (PDA) participates in a real-time, multimedia videoconferencing session while being highly mobile within a local campus or dense city limits, the videoconferencing application may be affected by various limitations of the wireless environment. These limitations may relate to conditions (e.g., channel traffic load) affecting all mobile devices within the same radio access network (RAN) or wireless local area network (WLAN), time-varying local conditions (e.g., fading, overlapped cells, etc.) occurring in the vicinity of the PDA, and conditions specific to the application flow (e.g., flow latency).

Current mechanisms have not been able to offset the above limitations of the wireless environment and typically lack the capability of delivering reliable services over an efficient, managed wireless infrastructure.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a wireless environment, in which one embodiment of a wireless resource control system operates.

FIG. 2 is a flow diagram of one embodiment of a process for providing a multi-tiered control of resources in a wireless environment.

FIG. 3 is a block diagram of one embodiment of a distributed wireless resource control system.

FIG. 4 is a block diagram of one embodiment of a wireless resource manager (WRM).

FIG. 5 is flow diagram of a one embodiment of a process for controlling global wireless resources within a wireless network.

FIG. 6 is a block diagram of one embodiment of a system for controlling local resources associated with a wireless device.

FIG. 7 is a flow diagram of one embodiment of a process for controlling local resources associated with a wireless device.

FIG. 8 illustrates operation of a distributed state machine.

FIG. 9 is a block diagram of an exemplary computer system.

### DETAILED DESCRIPTION

A method and apparatus for controlling resources in a wireless environment. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

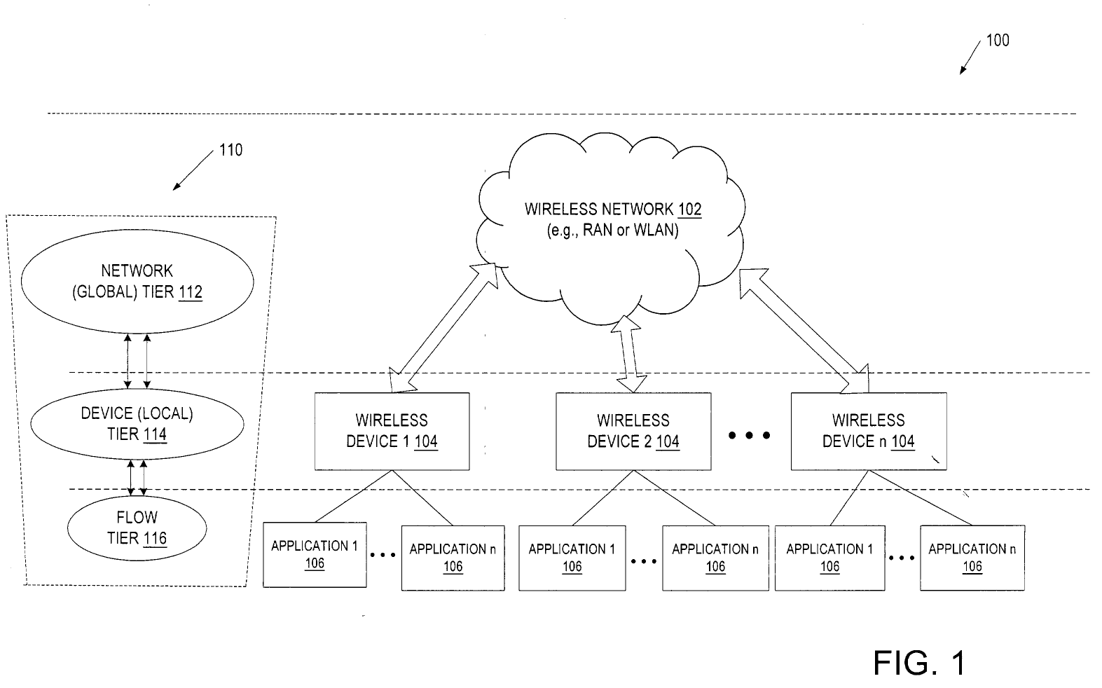

FIG. 1 illustrates one embodiment of a wireless environment 100, in which one embodiment of a wireless resource control system operates. Referring to FIG. 1, multiple wireless devices 104 are coupled to a wireless network 102, such as a radio access network (RAN) or wireless local area network (WLAN). A wireless device 104 may be a mobile client device (e.g., a cellular phone, a PDA, etc.) or a wireless controller station (e.g., a base station, a router, etc.). One or more software applications 106 are installed on each wireless device 104. Applications 106 initiate data flows that are to be sent to the wireless network 102. When the data flows are sent to the wireless network 102, they generate network traffic.

Application data flows are subject to several limitations of the wireless environment 100. As discussed above, these limitations may relate to conditions affecting all mobile devices 104 within the same wireless network 102. Such conditions (e.g., channel traffic load) are referred to herein as network or global conditions. The limitations of the wireless environment 100 may also relate to time-varying conditions (e.g., fading, overlapped cells, etc.) occurring in the vicinity of the wireless device 104. These time-varying conditions are referred to herein as local conditions. Further, the limitations of the wireless environment 100 may relate to application flow conditions, i.e., conditions that are specific to the application 106 generating data flows (e.g., flow latency).

Applications 106 may have different requirements for network resources with respect to their data flows. For example, the data flow generated by a wireless mailer application from an email message may require an insignificant amount of bandwidth if compared to the data flow generated by a video conferencing application during a live video conference session over a wide area wireless Internet connection. The video conferencing data flow may require guaranteed and uninterrupted high bandwidth.

One embodiment of the present invention provides a system that addresses the above limitations of the wireless environment 100 and manages wireless resources based on the conditions occurring at various levels of the wireless environment 100 and utility requirements of the applications 106. FIG. 1 illustrates a conceptual model 110 of a multi-tiered wireless resource control system.

The multi-tiered wireless resource control system provides separation of operations between the tiers while allowing data communications (e.g., policy and state information) between the tiers. In particular, each tier of the system performs monitoring of conditions occurring at the tier and then uses the results of monitoring to control resources associated with this tier. In one embodiment, the control is also accomplished using data received from other tiers.

In one embodiment, the resources are controlled by each tier of the system by evaluating the tier's conditions and adjusting a corresponding set of policies according to these conditions and data received from other tiers. The set of policies defines the criteria for resource access and usage. In one embodiment, each tier enforces the policies at a specific time scale. That is, a lower tier may enforce its set of policies at a faster time scale to improve conditions at the lower tier before the policies of a higher tier become active.

In one embodiment, a higher tier can request a reconfiguration of one or more components of a lower tier. The reconfiguration may include a modification of functionality of the components of the lower tier, a modification of a policy used by the components of the lower tier, and/or a modification of a parameter of the components of the lower tier.

In one embodiment, the multi-tiered wireless resource control system contains a network (or global) tier 112 and a device (or local) tier 114. The global tier 112 monitors conditions that affect all wireless devices 104 within the wireless network 102 (e.g., bandwidth within the wireless network 102) and controls access and usage of wireless network resources by data flows originated from all wireless devices 104 within the wireless network 102. The control performed by the global tier 112 may be based on external requirements (e.g., QoS policies imposed by a wide area network with which the wireless network 102 communicates) or an internally maintained set of policies. In addition, the control may be also in accordance with the global conditions and the information received from the local tier 114.

The local tier 114 monitors local conditions around a specific wireless device 104 (e.g., time-varying conditions such as fading and overlapped cells) and makes local policy decisions based on the local conditions, requirements of the data flows originated by the applications 106 running on the wireless device 104 and information received from the global tier 112.

In another embodiment, the multi-tiered wireless resource control system also contains a third tier, i.e., a flow tier 116. The flow tier 116 monitors conditions specific to an application 106 running on a wireless device 104 (e.g., flow latency and packet loss) and controls resources at the flow level (e.g., flow transmission rate, flow reliability) based on these conditions, data flow requirements of the application 106 and information received from the local tier 114.

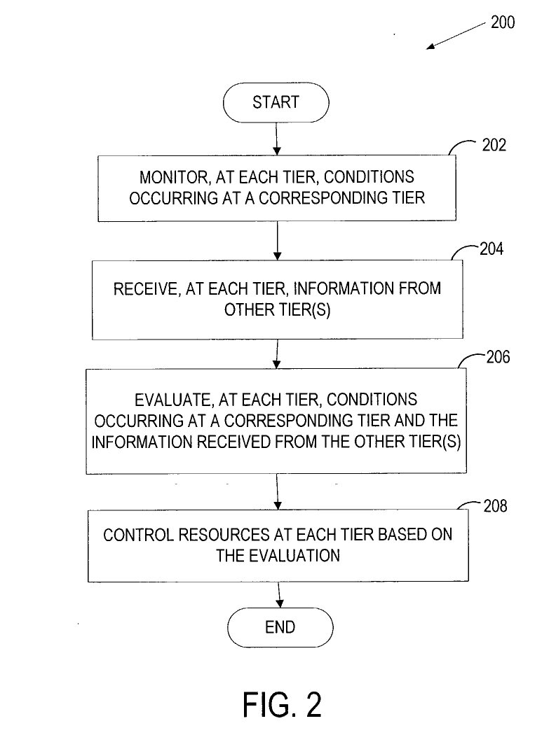

FIG. 2 is a flow diagram of one embodiment of a process 200 for providing a multi-tiered control of resources in a wireless environment. The process may be performed by processing logic that may comprise hardware (e.g., circuitry, dedicated logic, etc.), software (such as run on a general purpose computer system or a dedicated machine), or a combination of both. Processing logic operates at different tiers within the wireless environment. In one embodiment, the tiers include a global tier associated with all wireless devices within the same wireless network and a local tier associated with a specific wireless device within the wireless network. In another embodiment, the tiers also include a third tier referred to as a flow tier that is associated with a specific application installed on a wireless device within the wireless network.

Referring to FIG. 2, process 200 begins with processing logic monitoring, at each tier, conditions occurring at a corresponding tier (processing block 202). At processing block 204, processing logic at each tier receives information from other tier(s). This information may include, for example, policies maintained at the other tier, results of monitoring performed at the other tier, or a request from a higher tier to modify functionality, policy or some parameters of one or more components of this tier. For example, the local tier may receive a request from the global tier to add a specific service (e.g., to monitor an additional local condition) to one of the local tier's components, modify a policy (e.g., change a threshold at which monitoring of a local condition is conducted) used by the local tier's component, or modify a parameter (e.g., change the periodicity of the monitoring) of one of the local tier's components.

At processing block 206, processing logic at each tier evaluates the conditions occurring at a corresponding tier and the information received from the other tier(s). Based on this evaluation, processing logic controls resources at each tier (processing block 208). In one embodiment, processing logic controls resources by adjusting policies that define the criteria for resource access and usage at corresponding tiers and enforcing the adjusted policies at the corresponding tiers. In one embodiment, the policies are enforced at different time scales, i.e., the policies at a lower tier are enforced at a faster time scale than at a higher tier.

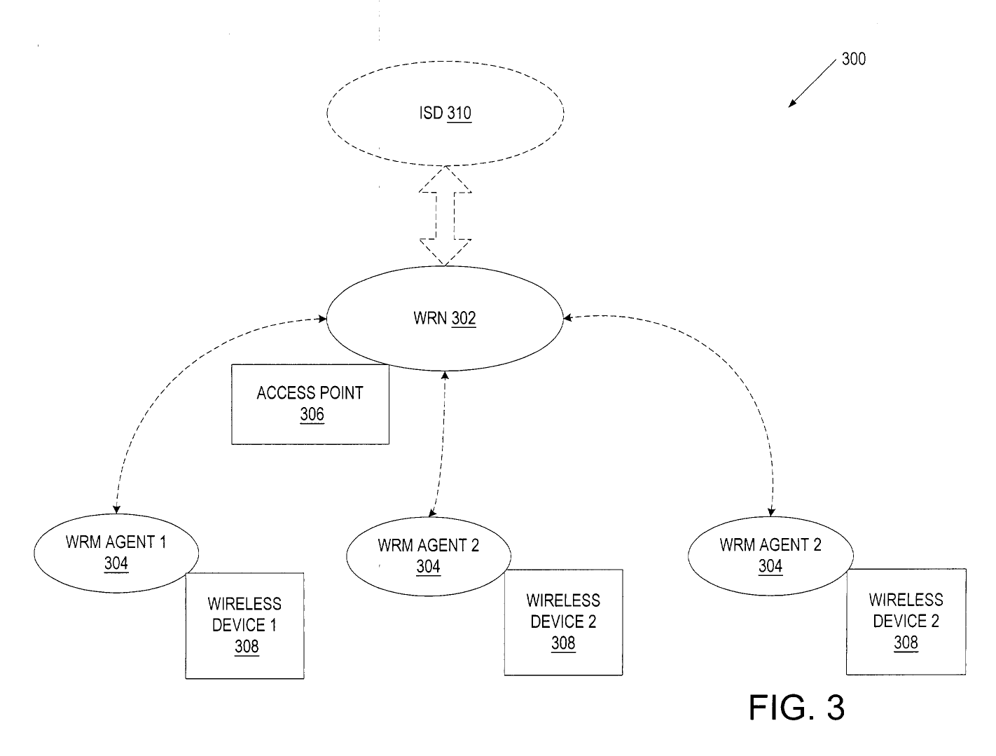

The multi-tiered wireless resource system discussed above with reference to FIG. 1 may be a distributed system. FIG. 3 is a block diagram of one embodiment of a distributed wireless resource control system 300.

Referring to FIG. 3, system 300 includes a wireless resource manager (WRM) 302 and multiple WRM agents 304 coupled to the WRM 302. The WRM 302 may reside anywhere within a wireless network such as a RAN or WLAN. For example, the WRM 302 may reside on a radio network access point (access point 306), base station, WLAN router, server, etc. Alternatively, the WRM 302 may function as a distributed system operating across multiple nodes within the wireless network.

WRM agents 304 reside on wireless devices 308. A wireless device 308 may be a mobile client device (e.g., a cellular phone, a PDA, etc.) or a wireless controller station (e.g., a base station, a router, etc.).

The WRM 302 and each WRM agent 304 may communicate using an application program interface such as a common object request broker architecture (CORBA) API.

The WRM 302 is responsible for monitoring global conditions (i.e., conditions within the wireless network) and providing resource control and management within the wireless network based on the global conditions. Global conditions may identify current reliability, performance and usage of the wireless network. In addition, the WRM 302 receives information from the WRM agents 304 (e.g., application-specific utility bandwidth specifications).

In one embodiment, the WRM 302 acts as a gateway to provision policies set by an external system (e.g., by an Internet Service Provider (ISP) 310). Alternatively, the WRM 302 can use an internal set of policies defined according to a particular standard (e.g., differentiated services (DiffServ) per hop behavior (PHB) specification, resource reservation protocol (RSVP) QoS specification, etc.).

When required by the conditions of the wireless network, the WRM 302 adjusts the current set of policies and uses the adjusted set of policies to optimize resource access and usage within the wireless network. In one embodiment, the adjustment is also based on the information received from the WRM agents 304 (e.g., application-specific utility bandwidth specifications).

In one embodiment, the WRM 302 sends certain data to the WRM agents 304. This data may include the adjusted policies, global condition information or a reconfiguration request. The reconfiguration request may contain a request to modify functionality of one or more WRM agents 304 (e.g., add a new service or modify or delete an existing service provided by any WRM agent 304), a policy used by one or more WRM agents 304 or a parameter of one or more WRM agents 304. In one embodiment, the reconfiguration request causes the corresponding WRM agent 304 to be reprogrammed in real time.

Each WRM agent 304 operates as a proxy to the WRM 302 and has its own autonomy. The WRM agent 304 accepts global policies delivered by the WRM 302 and makes the necessary local enforcement decisions. In particular, the RRM agent 304 assesses the time-varying conditions around a corresponding wireless device 308 and manages these conditions against the requirements of the running applications' flows and global conditions. In one embodiment, the RRM agent 304 collects information on time-varying local conditions (e.g., signal to noise-plus-interference ration (SINR) via a data link (media access control (MAC)) layer entity, as will be described in more detail below.

In one embodiment, local policies maintained by the WRM agent 304 preempt (using a faster time scale) the global policies in order to address problems created by time-varying local conditions (e.g., a fading or degraded local conditions on one or more flows). The global policies become active once the WRM 304 improves the local conditions.

The local policies maintained by the WRM agent 304 can be uniform across all flows running on the wireless device 308 or weighted (prioritized) according to specific QoS specifications.

Further, the WRM agent 304 is responsible for providing application flow control and adaptation. Specifically, the WRM agent 304 assesses flow conditions and controls flow rate and reliability based on the flow conditions. In one embodiment, the WRM agent 304 collects information on flow conditions (e.g., flow latency and losses and flow transmission rate) via a transport layer entity and a network layer entity, as will be described in more detail below.

The WRM agent 304 and protocol stack layer entities may communicate using APIs such as CORBA APIs.

In one embodiment, the WRM agent 304 is also responsible for providing coordination between protocol stack layer entities by exchanging current policy and state information between the protocol stack layer entities. In addition, in one embodiment, the WRM agent 304 has the ability of reconfiguring the protocol stack layer entities, as will be described in more detail below.

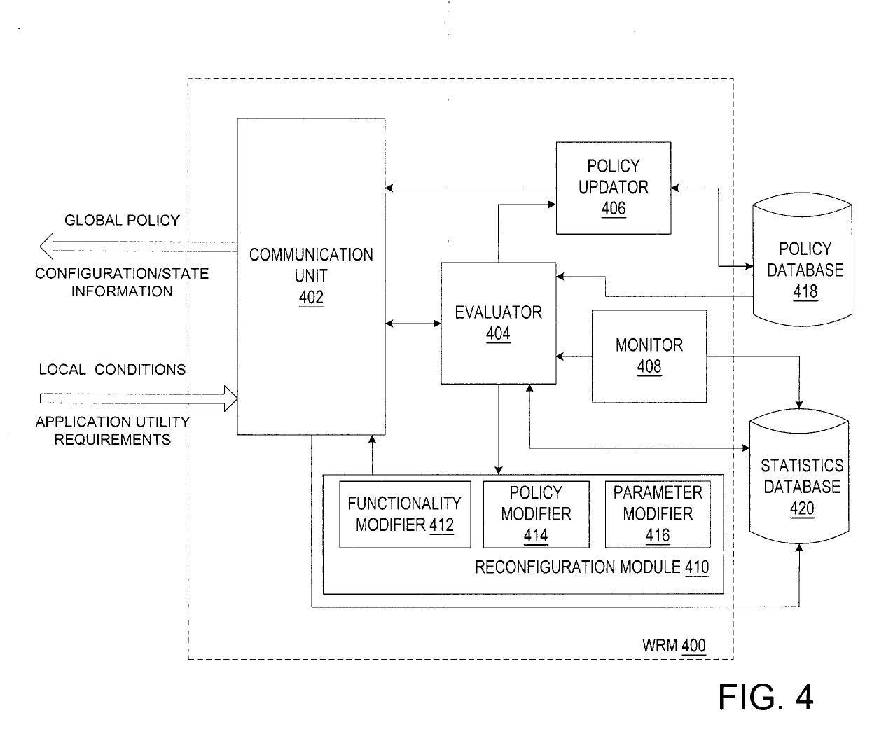

FIG. 4 is a block diagram of one embodiment of a wireless resource manager (WRM) 400. The WRM 400 includes a communication unit 402, an evaluator 404, a policy updator 406, a monitor 408, and a reconfiguration module 410.

The monitor 408 is responsible for monitoring conditions within the wireless network (i.e., global conditions). The global conditions represent current usage, reliability and performance of the wireless network. The monitor 408 stores some or all of the monitoring results in the statistics database to support feedback mechanisms of the WRM 400 and provides the monitoring results to the evaluator 404 for analysis.

The communication unit 402 receives information from multiple WRM agents. This information may pertain to local conditions, i.e., conditions affecting each wireless device coupled to the wireless network, and utility requirements of applications installed on the wireless devices. The utility requirements may be in the form of bandwidth utility functions or any other quantitative or qualitative specifications.

The evaluator 404 receives data from various sources within the WRM 400. These sources may be any combination of the monitor 408, the communication unit 402, the statistics database 429, and a policy database 418. The policy database 418 stores various policies pertaining to control of wireless resources within the wireless network. These policies may include multiple thresholds for the wireless channel access and utilization, specific QoS categories and various other data. The policies may be requested outside of the wireless network (e.g., WAN) or defined internally based on certain standards (e.g., DiffServ PHBs specs, RSVP QoS_Spec, etc.). In one embodiment, the WRM 400 supports an existing policy-based management system. Alternatively, if no existing policy-based management system is in place, the WRM 400 may act as an independent policy-based management entity.

Based on the obtained information, the evaluator 404 determines whether the current policies need to be updated. If policy update is required, the evaluator 404 informs the policy updator 406 about the required update. The policy updator 406 then adjusts the current policies stored in the policy database 418. In one embodiment, the policy updator 406 also sends the updated set of policies to the communication unit 402 which then communicates the updated set of policies to the WRM agents.

In one embodiment, the evaluator 404 stores some of the information received from the WRM agents (e.g., local condition data) in the statistics database 420. In addition, in one embodiment, the evaluator 404 may determine that the WRM agents need to be informed about certain global conditions (i.e., the current state of global resources) based on data received from the monitor 408. Once this determination is made, the evaluator 404 transfers this information to the communication unit 402, which then communicates it to the WRM agents.

In one embodiment, the evaluator 404 analyzes the obtained information to determine whether a reconfiguration of any WRM agents is required. The reconfiguration may relate to specific services performed by the WRM agents, policies used by the WRM agents when performing the services, or parameters of services performed by the WRM agents. If the reconfiguration is required, the evaluator 404 transfers control to the reconfiguration module 410.

The reconfiguration module 410 includes a functionality modifier 412, a policy modifier 414 and a parameter modifier 416. The functionality modifier 412 is responsible for creating a request to add a new service to one or more WRM agents or modify or delete an existing service performed by one or more WRM agents. For example, a new service to be added may be a service for transforming various forms of application utility specifications obtained by the WRM agents into a specific form which will then be transferred to the WRM 400. The new service may be downloaded to the agents via the WRM 400 in a centralized fashion, and the functionality modifier 412 will issue a request identifying this new service and specifying other relevant information.

The policy modifier 414 is responsible for creating a request to change a policy used by a particular service of the WRM agents (e.g., a request to measure a new parameter in addition to the parameters being currently measured when a certain threshold is reached). The parameter modifier 416 is responsible for creating a request to change a parameter of a particular service of the WRM agents (e.g., a request to change a threshold at which measurement of a certain parameter).

Once the configuration request is created, it is communicated to the corresponding WRM agents via the communication unit 402, causing a requested reconfiguration of the WRM agents in real time.

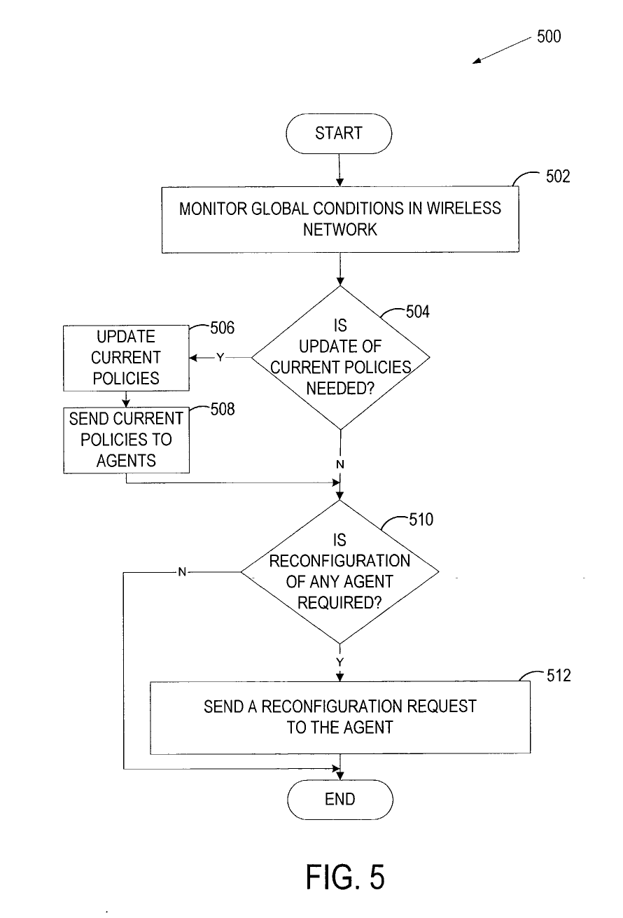

FIG. 5 is flow diagram of a one embodiment of a process 500 for controlling wireless resources within a wireless network. The process may be performed by processing logic that may comprise hardware (e.g., circuitry, dedicated logic, etc.), software (such as run on a general purpose computer system or a dedicated machine), or a combination of both.

Referring to FIG. 5, process 500 begins with processing logic monitoring global conditions (processing block 502). Next, processing logic determines whether an update of a current set of policies is required based on the result of monitoring (decision box 504). For this determination, processing logic may also use information received from agents servicing wireless devices coupled to the wireless network, and/or existing statistical information.

If the determination made at decision box 504 is positive, processing logic performs the update (processing block 506) and sends the updated set of policies to the agents (processing block 508).

Further, processing logic determines whether a reconfiguration of one or more of the agents is required (decision box 510). As discussed above, the reconfiguration may relate to a specific service performed by the agents, a policy used by the agents when performing the service, or a parameter of a service performed by the agents.

If a reconfiguration is required, processing logic creates a reconfiguration request (processing block 512) and communicates the reconfiguration request to one or more agents (processing block 514).

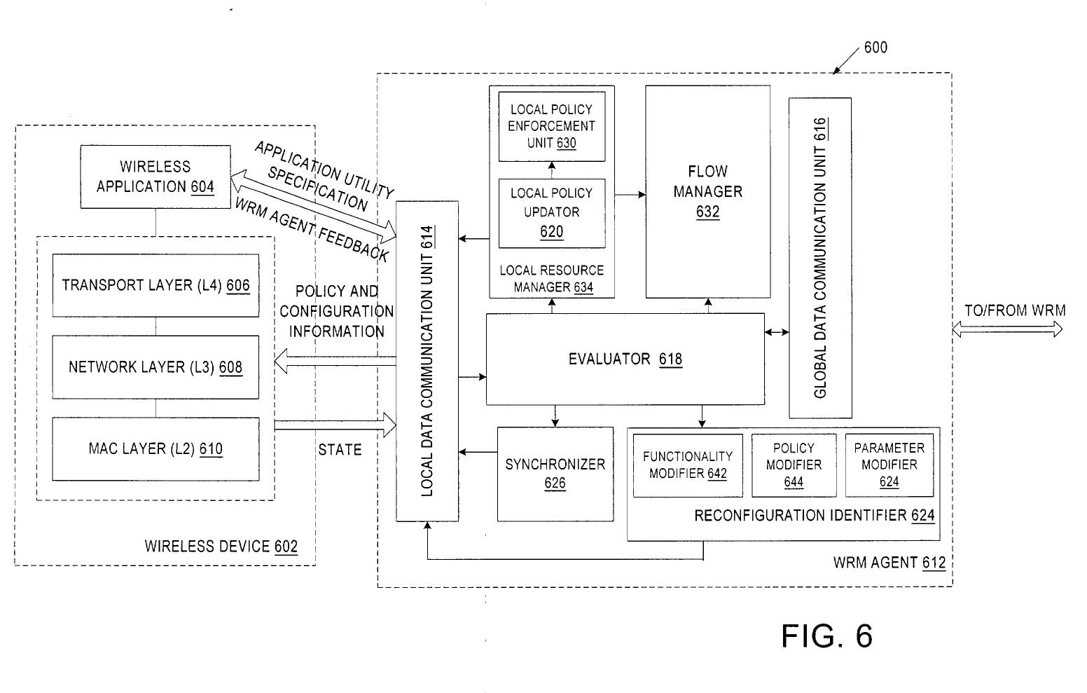

FIG. 6 is a block diagram of one embodiment of a system 600 for controlling resources associated with a wireless device. The system 600 includes a WRM agent 612 servicing, in cooperation with protocol stack layer entities, a wireless device 602 to allow the wireless device 602 to compete more aggressively for the wireless channel. The protocol stack layer entities include a transport layer (L4) entity 606, a network layer (L3) entity 608 and a MAC layer (L2) entity 610.

The WRM agent 612 is responsible for managing local resources and flow control and adaptation. The WRM agent 612 includes a local data communication unit 614, a global data communication unit 616, an evaluator 618, a local resource manager 634, a flow manager 632, a synchronizer 626, and a reconfiguration identifier 624.

The local data communication unit 614 receives data from local wireless applications (e.g., application utility specifications), the transport layer 606 (e.g., flow latency and packet loss parameters), the network layer 608 (e.g., flow transmission rate) and the MAC layer 610 (e.g., SINR parameters). The global data communication unit 614 receives data from the WRM (e.g., global policies, global condition data). In one embodiment, the communication between the WRM agent 612 and external entities is achieved via CORBA APIs.

The evaluator 618 receives information from the local data communication unit 614 and the global data communication unit 614, analyzes this information, and invokes different processes operating in the WRM agent 612 based on the analysis. These processes are mainly performed by the local resource manager 634, the flow manager 632, the synchronizer 626, and the reconfiguration identifier 624.

In particular, the evaluator 618 receives information pertaining to current global conditions provided by the WRM and information pertaining to time-varying conditions in the vicinity of the wireless device 602. In one embodiment, the information pertaining to time-varying local conditions is provided by the MAC layer 610. Specifically, the MAC layer 610 monitors local channel conditions and communicates the results of monitoring (i.e., channel state and metrics) to the WRM agent 612. In one embodiment, the MAC layer 610 uses a SINR monitoring function to continuously fast monitor the time-varying local conditions.

The evaluator 618 evaluates the time-varying conditions, the current global conditions and application utility specifications (e.g., SINR utility functions), and determines whether local adjustments need to be made to the current set of global policies. If local adjustments are required, the evaluator 618 informs the local resource manager 634 about the adjustments.

The evaluator 618 may also evaluate current and local conditions to determine whether the application utility specifications can be accommodated. Based on this determination, the evaluator 618 may send feedback to the wireless application 604. If the feedback indicates that the network cannot currently accommodate the application utility specifications (e.g., due to reduced bandwidth availability in the global network that is caused by congestion or consistent lossy or fading conditions detected locally or globally), the wireless application 604 may need to adjust accordingly against the current network constraints.

In addition, the evaluator 618 receives flow metrics and state information and communicates this information with relevant thresholds included in the current local policies to the flow manager 632. In one embodiment, the flow metrics and state information includes flow latency and packet loss parameters provided by the network layer 608 and flow transmission rate parameters provided by the network layer 608.

Further, the evaluator 618 selects current state and policy information from the obtained information and communicates this information to the synchronizer 626.

In one embodiment, the evaluator 618 analyzes the obtained information to determine whether a reconfiguration of any protocol stack layer entity is needed. This determination can be made based on current requirements within the global or local policies, global or local conditions, or any other pertinent information. The reconfiguration can relate to a specific parameter (e.g., a measurement frequency), policy (e.g., a rule for monitoring) associated with any protocol stack layer entity, or a service performed by any protocol stack entity. If the reconfiguration is required, the evaluator informs the reconfiguration identifier 624 about it.

In one embodiment, the evaluator 618 also determines which local data (e.g., application bandwidth utility specifications, local condition information) is to be transferred to the global data communication unit 616 for subsequent communication to the WRM.

The local resource manager 634 includes a local policy updator 620 and a local policy enforcement unit 630. The local policy updator 620 makes local adjustment to the global policies and communicates the adjusted policies to the local data communication unit 614 for the transfer to the network layer 608. In one embodiment, the adjusted policies provide uniformity and fairness to all flows running on the wireless device 602. Alternatively, the adjusted policies provide a prioritization among the local flows according to specific QoS requirements.

In addition, in one embodiment, the local policy updator 620 controls mapping of the global QoS policies into MAC layer QoS policies (e.g., via pre-configured class of service (CoS)/QoS header field mapping) based on the instructions received from the evaluator 618. In one embodiment, the local policy updator 620 may also update the MAC layer QoS policies directly based on the instructions received from the evaluator 618.

The local policy enforcement unit 630 controls enforcement of the MAC layer policies and global policies. The MAC layer policies are applied to application flows at a faster time scale to address issues caused by fading or other degraded local conditions on one or more flows. The use of a faster time scale for the MAC layer policies (which may or may not conflict with the global policies) allows the MAC layer to improve the local channel conditions before the global policies become active.

The flow manager 632 of the WRM agent 612 manages flow control and adaptation for the wireless application 604 using information provided by the evaluator 618 (i.e., the flow metrics and state information and the thresholds contained in the current local policies). The flow manager 632 manages flow reliability using reliability control mechanisms of the transport layer 606 and flow congestion using congestion control mechanisms of the transport layer 606 and network layer 608.

The synchronizer 626 provides coordination between the protocol stack layer entities. The synchronizer 626 makes state and policy information available between the protocol stack layer entities to maintain synchronization or resynchronization induced by global policy changes, local policy changes, or flow adaptation. The coordination between the protocol stack entities may enable synchronization between transport (per flow) congestion control and reliability states, network layer QoS policies and flow policing state, global usage and SINR state. Such coordination may, for example, happen using header information, inter-layer header mapping, or via method invocation and parameter passing.

The reconfiguration identifier 624 is responsible for issuing reconfiguration requests. The reconfiguration identifier 624 includes a parameter modifier 646 to create reconfiguration requests to modify parameters (e.g., a measurement frequency), a policy modifier 644 to create reconfiguration requests to modify policies (e.g., a rule for monitoring) associated with protocol stack layer entities, and a functionality modifier 642 to create reconfiguration requests to modify or remove existing services or add new services to be performed by any protocol stack entity. In particular, alternative transport layer control schemes can be configured in real time to provide greater flexibility to the multiple, varying conditions exhibited by the wireless channel. In one embodiment, if a real time reconfiguration of the transport layer 606 creates transport connection inconsistency (e.g., in case of a transport connection over several LAN/WAN networks consisting of both wireline and wireless underlying link transports), a designated service mechanism is provided by the programmable transport layer 606 to allow network nodes to reconfigure the transport layer dynamically to synchronize transport services during connection setup.

The network layer 608 can be reconfigured to employ and bind alternative QoS algorithms and services. Similarly, the MAC layer 610 can be reconfigured to employ and bind alternative MAC level QoS algorithms and services.

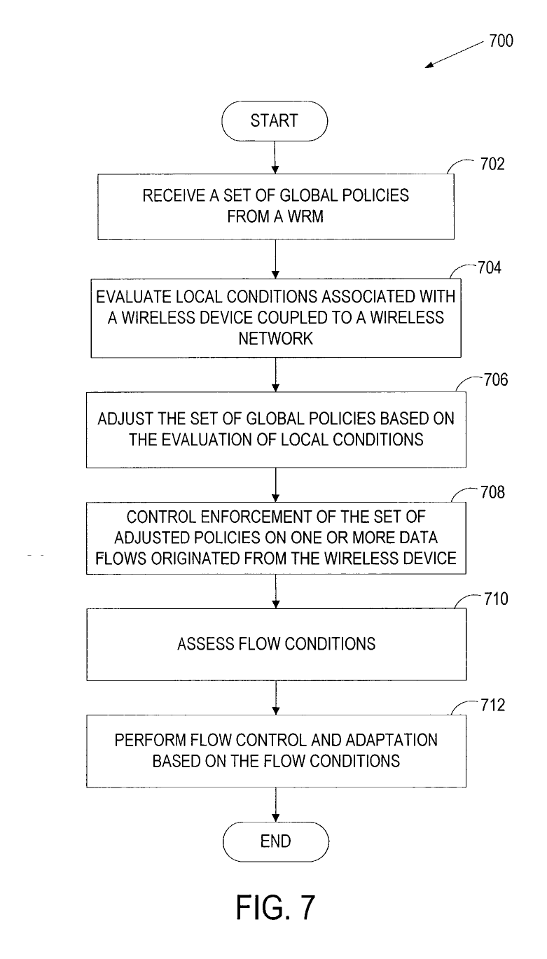

FIG. 7 is a flow diagram of one embodiment of a process 700 for controlling local resources associated with a wireless device. The process may be performed by processing logic that may comprise hardware (e.g., circuitry, dedicated logic, etc.), software (such as run on a general purpose computer system or a dedicated machine), or a combination of both.

Referring to FIG. 7, process 700 begins with processing logic receiving a set of global policies from a WRM (processing block 702). At processing block 704, processing logic evaluates local conditions (e.g., fading, overlapped cells) associated with a specific wireless device. In one embodiment, local conditions are identified based on SINR monitoring performed by a MAC layer entity. Next, processing logic adjusts the set of global policies based on the local conditions and utility specifications of applications running on the wireless device (processing block 706) and then controls enforcement of the adjusted policies on data flows originated from the wireless device (processing block 708). In one embodiment, MAC layer QoS policies mapped from the adjusted policies are enforced at a faster time scale to improve local channel conditions before the adjusted global policies become active.

Further, processing logic assesses flow conditions based on flow state and metrics provided by a transport layer entity and a network layer entity per application flow (processing block 710) and then performs flow control and adaptation based on the flow conditions (processing block 712).

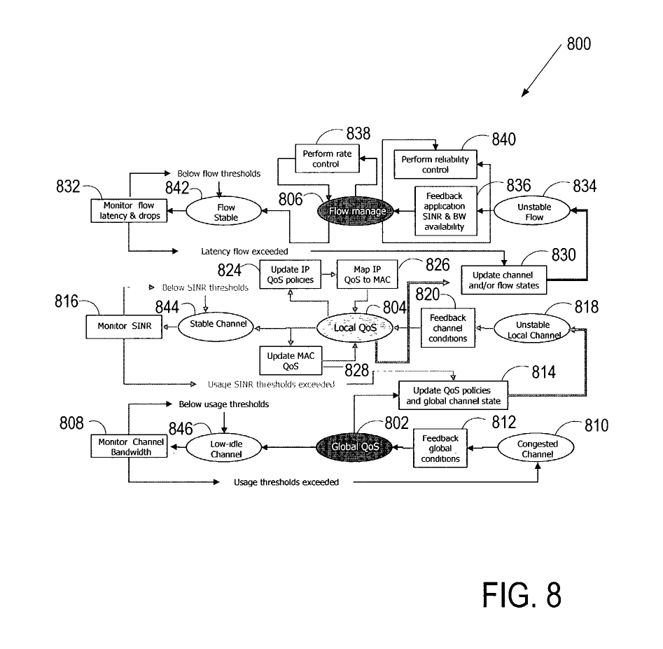

FIG. 8 illustrates operation of a distributed state machine 800. The distributed state machine 800 supports three autonomous levels of feedback-based control—a global level, a local level and a flow level. While each of the three levels is directed at a different set of objectives (e.g., global usage efficiency, local access maximization and fairness, and end-to-end flow control and adaptation), the three levels are overlapped on their influence on the wireless channel resource. Multiple instances of the state machine procedure will run, with one instance per wireless device and one instance for each flow running within the wireless environment.

At each level, a stable and unstable state exists, with an operational state being centered between them to represent the control state. In addition, at each level, a monitoring procedure checks against stability thresholds to determine the possibility of instability and the need to enter into a control state, invoking alternative algorithms that manage the particular level of concern.

At the global level, channel bandwidth monitoring 808 detects an unstable state 810 of the global wireless channel, at which the global control state (i.e., global QoS) 802 is entered into. Global QoS 802 evaluates global conditions using global conditions feedback mechanism 812 and performs update 814 of QoS policies in accordance with the global conditions. The policy update may bring the global channel into a stable state 846 but may also cause the state machine 800 to go into an unstable local channel state 818. The unstable local channel state 818 also occurs when SINR monitoring 816 determines that a SINR threshold has been exceeded.

In response to the unstable local channel state 818, local QoS 804 driven by channel condition feedback 820 performs update 824 of network layer (IP) QoS policies and mapping 826 of IP QoS policies to MAC QoS policies and update 828 of MAC QoS policies. Enforcement of MAC QoS policies and IP QoS policies (at different time scales) will result in update 830 of the channel state and/or flow state, which may cause the state machine 800 to enter into stable local channel state 844. In the meantime, the update of local policies may result in an unstable flow state 834. The unstable flow state 834 may also occur as a result of monitoring process 832 when it determines that flow latency and packet drops have exceeded flow thresholds.

When the unstable flow state 834 occurs, flow manage process 806 uses feedback 836 of application SINR state and bandwidth availability and performs flow rate control 838 and flow reliability control 840, causing the state machine to enter into a stable flow state 842.

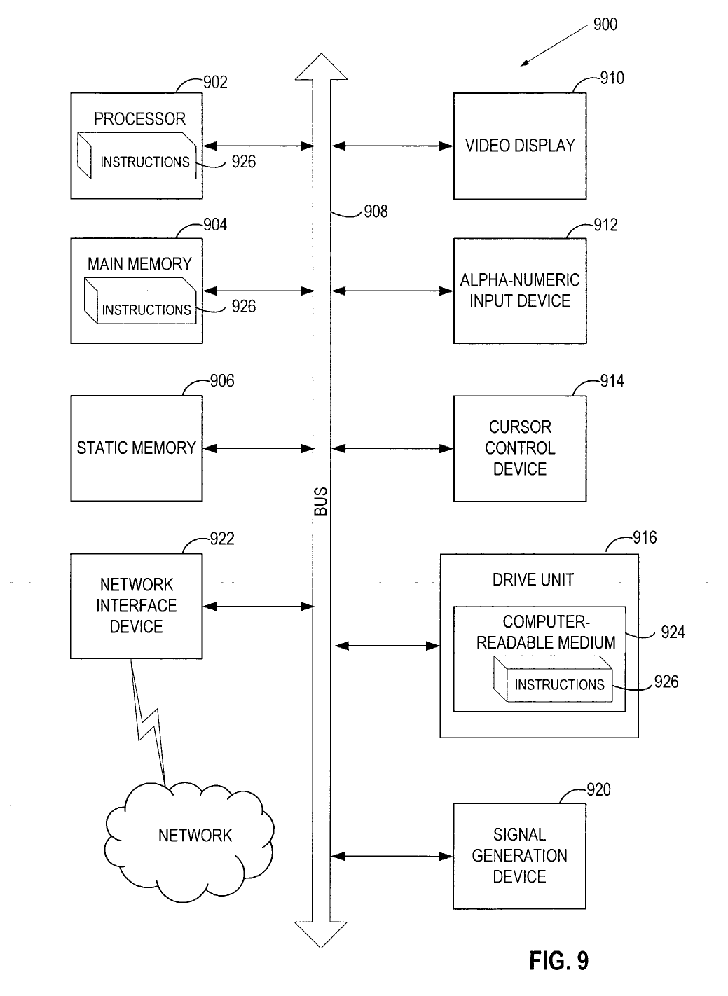

FIG. 9 is a block diagram of an exemplary computer system 900 that may be used to perform one or more of the operations described herein. In alternative embodiments, the machine may comprise a network server, a network gateway, a network router, a network switch, a network bridge, Personal Digital Assistant (PDA), a cellular telephone, a web appliance or any machine capable of executing a sequence of instructions that specify actions to be taken by that machine.

The computer system 900 includes a processor 902, a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 920 (e.g., a speaker) and a network interface device 922.

The disk drive unit 916 includes a computer-readable medium 924 on which is stored a set of instructions (i.e., software) 926 embodying any one, or all, of the methodologies described above. The software 926 is also shown to reside, completely or at least partially, within the main memory 904 and/or within the processor 902. The software 926 may further be transmitted or received via the network interface device 922. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A system comprising:
a plurality of wireless devices coupled to a wireless network, each of the plurality of wireless devices initiating one or more data flows sent to the wireless network; and
a multi-tiered wireless resource control service, coupled to the wireless network, to monitor, at each of multiple tiers, conditions pertaining to data flows originated from the plurality of wireless devices, and to control resources at said each of multiple tiers based on the monitoring, the multiple tiers comprising at least a first tier associated with the wireless network and a second tier associated with one of the plurality of wireless devices.

2. The system of claim 1 wherein the multiple tiers further comprises a third tier associated with an application running on the one of the plurality of wireless devices.

3. The system of claim 1 wherein the multi-tiered wireless resource control service is to control resources at said each of multiple tiers at a time scale specific to said each of multiple tiers.

4. The system of claim 3 wherein the multi-tiered wireless resource control service is further to provide exchange of data between the multiple tiers, the data comprising at least one of the adjusted set of policies, the monitoring results, and a request to reconfigure a component of the multi-tiered wireless resource control service that operates at a lower tier within the multiple tiers.

5. The system of claim 2 wherein the multi-tiered wireless resource control service comprises:
a wireless resource manager (WRM) operating at the first tier to manage global resources associated with the wireless network; and
a plurality of WRM agents, each of the plurality of WRM agents operating at the second tier to manage local resources associated with a corresponding one of the plurality of wireless devices based on local conditions and a set of policies received from the WRM, each of the plurality of WRM agents further operating at the third to facilitate adaptation of one or more data flows associated with an application running on the corresponding one of the plurality of wireless devices.

6. The system of claim 5 wherein each of the plurality of WRM agents operates in cooperation with a set of protocol stack layer entities including:
a programmable transport layer entity to employ alternative transport layer control schemes in real time for adaptation of the one or more data flows associated with the application;
a programmable network layer entity to bind alternative network layer QoS algorithms and services in real time for enforcement of network layer QoS policies on the one or more data flows associated with the application; and
a programmable media access control (MAC) layer protocol entity to map the network layer QoS policies to MAC layer QoS policies and to bind alternative MAC layer QoS algorithms and services in real time for enforcement of MAC layer QoS policies on the one or more data flows associated with the application, the enforcement of the MAC layer QoS policies occurring at a faster time scale than the enforcement of the network layer QoS policies.

7. The system of claim 6 wherein each of the plurality of WRM agents is to provide data exchange and coordination between the transport layer entity, the network layer entity and the MAC layer entity.

8. A method comprising:
monitoring, at each of multiple tiers, conditions pertaining to data flows originated from a plurality of wireless devices coupled to a wireless network, the multiple tiers including at least a first tier being associated with the wireless network and a second tier being associated with one of the plurality of wireless devices; and
controlling resources at each of the multiple tiers based on the monitoring.

9. The method of claim 8 wherein the multiple tiers further comprises a third tier associated with one of a plurality of applications running on the one of the plurality of wireless devices.

10. The method of claim 8 further comprising:
exchanging data between the multiple tiers, the exchanged data comprising at least one of the adjusted set of policies, the monitoring results, and a request to reconfigure a component of the multi-tiered wireless resource control service that operates at a lower tier within the multiple tiers.

11. A method comprising:
monitoring global conditions in a wireless network, the global conditions pertaining to operation of a plurality of wireless devices coupled to the wireless network;
determining that a reconfiguration of one or more of a plurality of agents associated with the plurality of wireless devices is required based on the monitoring; and
communicating a reconfiguration request to the one or more of the plurality of agents.

12. The method of claim 11 wherein the reconfiguration request comprises at least one of a request to modify functionality of the one or more agents, a request to modify a policy used by the one or more agents, and a request to modify a parameter of the one or more agents.

13. The method of claim 11 further comprising:
receiving information from the plurality of agents, the information including at least wireless network utility requirements of applications installed on the plurality of wireless devices; and
adjusting a current set of policies based on the monitoring and the information received from the plurality of agents.

14. An apparatus comprising:
a monitor to monitor global conditions in a wireless network, the global conditions pertaining to operation of a plurality of wireless devices coupled to the wireless network;
an evaluator to determine that a reconfiguration of one or more of a plurality of agents associated with the plurality of wireless devices is required based on the monitoring; and
a communication unit to communicate a reconfiguration request to the one or more of the plurality of agents in real time.

15. The apparatus of claim 14 further comprising a reconfiguration module to create the reconfiguration request, the reconfiguration module comprising:
a functionality modifier to request a modification of functionality of said one of the plurality of agents;
a policy modifier to request a modification of a policy used by said one of the plurality of agents; and
a parameter modifier to request a modification of a parameter of said one of the plurality of agents.

16. The apparatus of claim 14 wherein the evaluator is to further utilize information received from the plurality of agents when determining whether reconfiguration is needed.

17. A method comprising:
receiving a set of global policies from a wireless network resource manager;
evaluating local conditions associated with a wireless device coupled to a wireless network;
adjusting the set of global policies based on the evaluation of local conditions; and
controlling enforcement of the adjusted set of global policies on one or more data flows originated from the wireless device.

18. The method of claim 17 further comprising:
collecting information pertaining to the local conditions from a media access control (MAC) layer entity.

19. The method of claim 17 further comprising:
assessing flow conditions based on monitoring performed by any one of a transport layer entity, a network layer entity and a media access control (MAC) layer entity; and
managing flow control and adaptation based on the flow conditions.

20. The method of claim 17 further comprising:
triggering a reconfiguration of any one of a transport layer entity, a network layer entity and a media access control (MAC) layer entity based on the information pertaining to any of the local conditions, flow conditions and the set of global policies.

21. The method of claim 17 further comprising:
transferring policy and state data between a transport layer entity, a network layer entity and a media access control (MAC) layer entity.

22. An apparatus comprising:
a global data communication unit to receive a set of global policies from a wireless network resource manager;
an evaluator to evaluate local conditions associated with a wireless device coupled to a wireless network, to determine, based on the evaluation, whether the set of global policies needs to be adjusted;
a local policy manager to adjust the set of global policies when needed; and
a local policy enforcement unit to control enforcement of the adjusted set of global policies on one or more data flows originated from the wireless device.

23. The apparatus of claim 22 further comprising:
a global data communication unit to collect information pertaining to the local conditions from a media access control (MAC) layer entity.

24. The apparatus of claim 22 further comprising:
a flow manager to manage flow control and adaptation based on monitoring performed by any one of a transport layer entity, a network layer entity and a media access control (MAC) layer entity, and to.

25. The apparatus of claim 22 further comprising:
a reconfiguration identifier to trigger a reconfiguration of any one of a transport layer entity, a network layer entity and a media access control (MAC) layer entity based on the information pertaining to any of the local conditions, flow conditions and the set of global policies.

26. The apparatus of claim 22 further comprising:
a synchronizer to transfer policy and state data between a transport layer entity, a network layer entity and a media access control (MAC) layer entity.

27. A computer software product comprising one or more recordable media having executable instructions stored thereon which, when executed by a processing device, cause the processing device to:
monitor, at each of multiple tiers, conditions pertaining to data flows originated from a plurality of wireless devices coupled to a wireless network, the multiple tiers including at least a first tier being associated with the wireless network and a second tier being associated with one of the plurality of wireless devices; and
control resources at each of the multiple tiers based on the monitoring.

28. The computer software product of claim 27 wherein the multiple tiers further comprises a third tier associated with one of a plurality of applications running on the one of the plurality of wireless devices.

29. A computer software product comprising one or more recordable media having executable instructions stored thereon which, when executed by a processing device, cause the processing device to:
monitor global conditions in a wireless network, the global conditions pertaining to operation of a plurality of wireless devices coupled to the wireless network;
determine that a reconfiguration of one or more of a plurality of agents associated with the plurality of wireless devices is required based on the monitoring; and
communicate a reconfiguration request to the one or more of the plurality of agents.

30. The computer software product of claim 29 wherein the reconfiguration request comprises at least one of a request to modify functionality of the one or more agents, a request to modify a policy used by the one or more agents, and a request to modify a parameter of the one or more agents.
